(19) United States
(12) Patent Application Publication
(10) Pub. No.: US 2015/0289452 A1
(43) Pub. Date: Oct. 15, 2015

(54) Modular Living Green Wall System to Provide Heat Rejection

(71) Applicant: YALE UNIVERSITY, New Haven, CT (US)

(72) Inventors: James W. Axley, Guilford, CT (US); Alexander J. Felson, New Haven, CT (US); Jesse Ron Hudkins, Calgary (CA)

(73) Assignee: YALE UNIVERSITY, New Haven, CT (US)

(21) Appl. No.: 14/659,536

(22) Filed: Mar. 16, 2015

Related U.S. Application Data
(60) Provisional application No. 61/953,068, filed on Mar. 14, 2014.

(51) Int. Cl. A01G 9/02; A01G 27/00

(52) U.S. Cl. CPC A01G 9/025; A01G 27/008

(57) ABSTRACT

Modular living green wall systems are provided that supply water-cooled heat rejection for building cooling, power generation, industrial, chemical, and other processes that rely on heat rejection to the ambient environment for their efficient operation. Warm water from the process requiring heat rejection is circulated vertically through channels of porous media of the system and is cooled by evaporative and/or convective heat transfer to the ambient air that flows over and/or through the porous media across or counter to the water flow direction. Cool water leaving the system is piped to a heat exchanger of the process to provide the requisite cooling and is returned warm to the modular green wall system to complete the circulation loop. Modular living green wall systems may be assembled using plant modules and water treatment modules that are nested together to form continuous porous vertical water flow channels and a water recirculation system. The plant modules may consist of an inner porous media layer and an exposed porous substrate layer attached to each other and a stackable module housing. The water treatment module may be housed in a compatible stackable housing containing horizontal layers of filtration media. These modules are stacked in an interlocking manner and may be attached to an existing building support structure or alternatively be used to form a free standing living green wall.

### CROSS-REFERENCE TO RELATED APPLICATION(S)

The present application claims priority benefit to a co-pending provisional patent application entitled “Methods and Systems for Removing Heat from Process Colling (sic) Fluid Used to Cool a Process Requiring Heat Rejection,” which was filed on Mar. 14, 2014, and assigned Ser. No. 61/953,068. The entire contents of the foregoing provisional patent application are incorporated herein by reference.

### BACKGROUND

1. Technical Field

The present disclosure is directed to systems and processes that involve heat rejection and/or heat exchange, such as district and building chilled water plants, thermoelectric power plants, industrial chemical processes, etc. In particular, the present disclosure is directed to systems and methods that may be associated with or attached to an exterior wall of a building or other vertical structure, or may be configured and implemented as a free standing system, to cool water or other fluid media that is recirculated from a heat exchanger or other process/equipment and that requires heat rejection and/or heat exchange.

2. Background Art

Cooling towers use evaporative cooling and are ubiquitously used across industry for heat rejection, consuming water and transferring waste heat to the atmosphere. As the water lost to the atmosphere via evaporation from these cooling towers can no longer be recycled, it constitutes a deficit in any region's water budget. Consequently, there is a clear incentive to seek the means to either reduce cooling tower water loss or to use the water that must be lost for other useful purposes.

Chillers, power generation and many other industrial processes require heat rejection to properly operate. Most conspicuous are the cooling towers used in thermoelectric power generation that evaporatively transfer water to the atmosphere at a rate, on average, of 0.47 gal (1.8 L) of water per kWh of electricity generated, or approximately 1.5×10¹² gal (5.7×1015 L) for the total US thermoelectric power production of nearly 3.2×10¹² kWh/year. This is a formidable water consumption rate equal to 1% of all fresh and saline water withdrawals in the United States or just over 9% of all public water supply withdrawals. Indeed, on a typical hot day, the Yale University power plant uses about 137,000 gallons of water while another 32,000 gallons of water is lost to remove the mineral deposits from chemicals and salts (this lost water is referred to as “blow-down”). This level of water usage—particularly when extrapolated across the many cooling tower applications that pervade industry—is highly disadvantageous and wasteful.

Although these significant water consumption rates are troubling, it must be recognized that water-cooled (cooling tower) heat rejection is generally preferable to air-cooled heat rejection. For example, in a comprehensive study of building cooling systems in downtown Hong Kong, chiller plant coefficients of performance (COP) were approximately 3.0 for air-cooled systems and 5.0 for water-cooled systems under identical climatic conditions, translating to 67% more cooling with a water-cooled system for the same power input.

The waste heat from conventional processes is generally transferred to a refrigerant in either an open or closed circuit cooling tower. An open circuit is one in which the evaporating fluid (e.g., water) and working fluid are the same. A closed circuit is one in which the evaporative fluid and working fluid are different. For example, a closed circuit system may include water that is cooled from evaporation and heat from the working fluid is transferred to the water.

While cooling towers are ubiquitous across industry, there are problems with cooling towers that create opportunities for improved systems for heat rejection and/or heat exchange. For example, cooling towers create an environment where Legionella bacteria, a deadly bacterium if inhaled, can grow. Consequently, biocides are added to cooling towers to control potential bacterial issues. In addition, corrosion inhibitors are frequently added to cooling towers in an effort to reduce maintenance issues associated with corrosion. These additives add cost to system operation and contaminate the evaporating fluid, which, in turn, makes disposal of blow-down water an environmental concern.

Green technology is a growing trend throughout the world. Concern with climate change and the effect of pollution on the environment has encouraged a global movement towards more environmentally friendly technology. One implementation of green-oriented technology is evidenced in the incorporation of plants in architectural structures and designs.

Architectural structures are typically utilitarian in nature and may have limited aesthetic appeal. In order to capture the spirit of green-oriented technology, some structures have been created that implement living plants in the design. Typically, these structures have been simple structures that use conventional hanging plant displays. These standard types of structures provide flora, but they do not permit expansion, easy replacement and have limited versatility. Furthermore, these standard types of displays fail to provide irrigation systems for soil-based plants.

Despite efforts to date, a need remains for systems/methods that provide cooling for buildings while minimizing energy and water consumption, urban heat island impacts, and greenhouse gas emissions. In addition, a need exists for systems and methods that provide living walls that are easily expandable, permit easy replacement of plants, easy maintenance, provide ample versatility for the formation of structures and provide a continuing source of irrigation. These and other needs are satisfied by the systems and methods of the present disclosure.

### SUMMARY

The present disclosure provides advantageous systems and methods for combining green wall technology/functionality with heat removal/heat exchange technology/functionality. In exemplary embodiments of the present disclosure, a modular living green wall system is provided that facilitates water-cooled heat rejection/heat exchange for building cooling, power generation, industrial, chemical, and other processes that rely on heat rejection/heat exchange to the ambient environment for their efficient operation. Warm water from the process requiring heat rejection/heat exchange may be circulated, e.g., vertically through porous media of the system, and is cooled by evaporative and/or convective heat transfer to ambient air, e.g., to ambient air that flows through or over the porous media across and/or counter to the water flow direction.

In exemplary embodiments, cool water leaving the disclosed modular green wall system may be fed to a heat exchanger, e.g., through appropriate piping, to provide the requisite cooling. After passage through the heat exchanger, the warmed water may be returned to the modular green wall system to complete a circulation loop. In some exemplary embodiments, substrate and complementary water filtration media may be integrated in the modular living green wall system, thereby functioning to maintain or enhance water quality and/or allow grey water to be used to make-up water losses due to evaporation.

In further exemplary embodiments, a modular living green wall system according to the present disclosure may be assembled using plant modules and water filtration modules that are nested together to form continuous porous vertical water flow passages and a water recirculation system. The plant modules may include one or more porous media layers and an exposed porous substrate layer attached to and/or integrated with each other. The plant modules may be mounted or otherwise supported by a module housing. Module housings may be configured and dimensioned to facilitate stacking or other interconnection, thereby permitting modular assembly thereof. The module housings may be fabricated from conventional materials, e.g., metal, plastic and/or fiber reinforced plastic.

The water filtration modules of the present disclosure may include fiber-reinforced side walls/faces and perforated back walls/faces. The water filtration module may be housed in a compatible stackable housing with non-perforated front, back and side walls/faces containing one or more horizontal layers of filtration media. These modules may be advantageously stacked in an interlocking manner and may be attached to an existing wall support structure, mounted with respect to an existing wall support structure, or alternatively be used to form a free standing living green wall.

Thus, in an exemplary embodiment of the present disclosure, a “thermo green wall” (tGW) is provided that offers the combined functionalities of a green wall and a cooling tower. The green wall functionality is highly advantageous because, inter alia, it may be associated with a building's facade or other vertical structure and may provide one or more of the following benefits:
Acoustic benefits, e.g., plants associated with the green wall may absorb and/or refract acoustic energy generated in connection with cooling tower operations.
Building protection benefits, e.g., the green wall can shield a building, in whole or in part, from sun radiation/solar exposure, rain and other environmental forces that may degrade exterior wall finishes or otherwise damage/degrade a wall, façade or other vertical structure, including the potentially negative effects of air pollution and air-borne particulates. Through manipulation of the form, detail and positioning of a green wall, glazed wall openings may be shaded to minimize solar gain and thus reduce building cooling loads. The reduction of wall surface temperatures and their diurnal variation coupled to reduced UV exposure provided by the shading of a green wall system may also improve the durability of most wall constructions. In addition, green walls provide a rain screen that limits direct rainfall impacts on wall surfaces and moderates wind driven air pressures that tend to drive rainwater into wall constructions, both contributing to the durability of most wall constructions.
Urban microclimate benefits, e.g., plants associated with the green wall can have a natural cooling effect on the environment through photosynthesis and evapotranspiration (and in some cases enhancing long wave back radiation to the overhead sky), thereby mitigating undesirable “urban heat island” effects.
Moderation/attenuation of building temperature, e.g., green walls can moderate/attenuate exterior surface temperatures of walls, facades and other vertical structures, thereby reducing the heating/cooling requirements of a building/structure. Green walls may provide direct and comprehensive shading of a wall, façade or other vertical structure and may thereby reduce solar absorption. Both wall surface temperatures and the diurnal variation of those surface temperatures may be reduced. In addition, the presence of the green wall alters convective heat transport at the wall surface, increasing the so-called “film” resistance of the air boundary layer immediately adjacent to the wall, marginally increasing the overall thermal resistance of the wall construction. During summer conditions, reduced surface temperatures and increased wall resistance serve to reduce cooling loads on the building. Green walls may increase energy consumption in the winter due to the shading of a building, but the effect of climate modification and wind speed reduction may more than compensate, leading to substantial reduction in energy consumption.
Wildlife benefits, e.g., green walls may establish a nurturing/supportive wildlife habitat for a variety of birds, some small animals, insects, mesoorganisms and microorganisms. If developed with biodiverse plant communities, the habitat benefit may be further enhanced.
Aesthetic benefits, e.g., green walls can add to the décor of a façade or other vertical structure, and provide a desirable sense of privacy and enclosure.
Stormwater management benefits, e.g., green walls may help to moderate runoff from stormwater.
Air quality benefits, e.g., green walls with green plants can absorb gaseous air pollutants and transform them biochemically, as well as intercept airborne particulates, retaining them on their surfaces or, in some cases, absorbing them.
Carbon sequestration benefits, e.g., green walls may serve to sequester carbon in direct proportion to its biomass.

The disclosed tGW provides the noted advantages of green wall functionality while simultaneously delivering beneficial thermodynamic functionalities associated with cooling tower operation, i.e., heat rejection and/or heat exchange. Of further note, the disclosed tGW advantageously eliminates and/or reduces blow-down requirements associated with typical cooling tower operation because plants associated with the tGW function to extract many minerals and salts from the water flow. Furthermore, the disclosed tGW strategically uses water resources, e.g., by using evaporative fluid (water) to water plants, thereby creating a living environment. In exemplary implementations of the present disclosure, the disclosed systems may include integrated water biofiltration capability/functionality.

The disclosed systems and methods may be implemented through a wide range of physical support and attachment systems, irrigation systems, plant communities, substrates, and plant containers. Moreover, the disclosed systems and methods may be employed to supplement or replace urban cooling tower infrastructure while maintaining the established benefits that green walls provide and utilizing, in whole or in part, available components of existing green wall systems.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

To assist those of ordinary skill in the art in making and using the systems and methods of the present disclosure, reference is made to the accompanying figures, wherein:

FIG. 1 is a front perspective view of a heat-rejecting living green wall module according to embodiments of the disclosed subject matter;

FIG. 2 is a rear perspective view of a heat-rejecting living green wall module according to embodiments of the disclosed subject matter;

FIG. 3 is a sectional perspective view of a heat-rejecting living green wall module according to embodiments of the disclosed subject matter, which shows the vertical downward flow of recirculated water and the cross/partial-counter flow of ambient air;

FIG. 4 is a cut-away sectional perspective view of a plant module according to embodiments of the disclosed subject matter, which shows layering of porous substrate and porous media;

FIG. 5 is a cut-away sectional perspective view of a water treatment module according to embodiments of the disclosed subject matter, which shows two of possibly multiple layers of water filtration media;

FIGS. 6-9 are schematic diagrams of water-cooling system according to embodiments of the disclosed subject matter; and

FIGS. 10-13 are test results for exemplary tests according to the present disclosure.

### DESCRIPTION OF EXEMPLARY EMBODIMENT(S)

The systems and methods of the present disclosure combine green wall technology/functionality with heat removal/heat exchange technology/functionality to address significant industrial and commercial needs. The disclosed green wall system facilitates water-cooled heat rejection/heat exchange for a range of industrial and commercial applications, including specifically building cooling, power generation, industrial and chemical processes and facilities. Warm water requiring heat rejection/heat exchange may be pumped/circulated to the disclosed system, and cooled by evaporative and/or convective heat transfer to ambient air. The cooled water may then be pumped/fed to a heat exchanger or other unit operation that transfers heat to a cooling fluid, where the cooled water may provide the requisite cooling. After passage through the heat exchanger/unit operation, the warmed water may be returned to the green wall system of the present disclosure to complete a circulation loop. Water filtration functionality may be integrated in the green wall system to maintain or enhance water quality and/or allow grey water to be used to make-up water losses due to evaporation.

The disclosed green wall system may be assembled using plant modules and water filtration modules that are nested together to form continuous porous vertical water flow passages and a water recirculation system. The plant modules may include one or more inner porous media layers and an exposed porous substrate layer attached to and/or integrated with each other. The plant modules may mounted or otherwise supported by a module housing. Module housings may be configured and dimensioned to facilitate stacking or other interconnection, thereby permitting modular assembly thereof. The module housings may be fabricated from conventional materials, e.g., metal, plastic and/or fiber reinforced plastic.

The water filtration modules of the present disclosure may include fiber-reinforced side walls/faces and perforated back walls/faces. The water filtration module may be housed in a compatible stackable housing with non-perforated front, back and side walls/faces containing one or more horizontal layers of filtration media. These modules may be advantageously stacked in an interlocking manner and may be attached to an existing wall support structure, mounted with respect to an existing wall support structure, or alternatively be used to form a free standing living green wall.

The green wall system of the present disclosure may be attached to an exterior wall of a building/structure or other substantially vertically-oriented or sloped structure, mounted with respect to an exterior wall of a building/structure or other substantially vertically-oriented or sloped structure, or configured as a free standing system, i.e., disposed independent and/or spaced from a building or structure. In each implementation, the disclosed green wall system advantageously functions to cools water that is circulated and/or recirculated from a heat exchanger or other unit operation that is associated with a process/system that requires heat rejection.

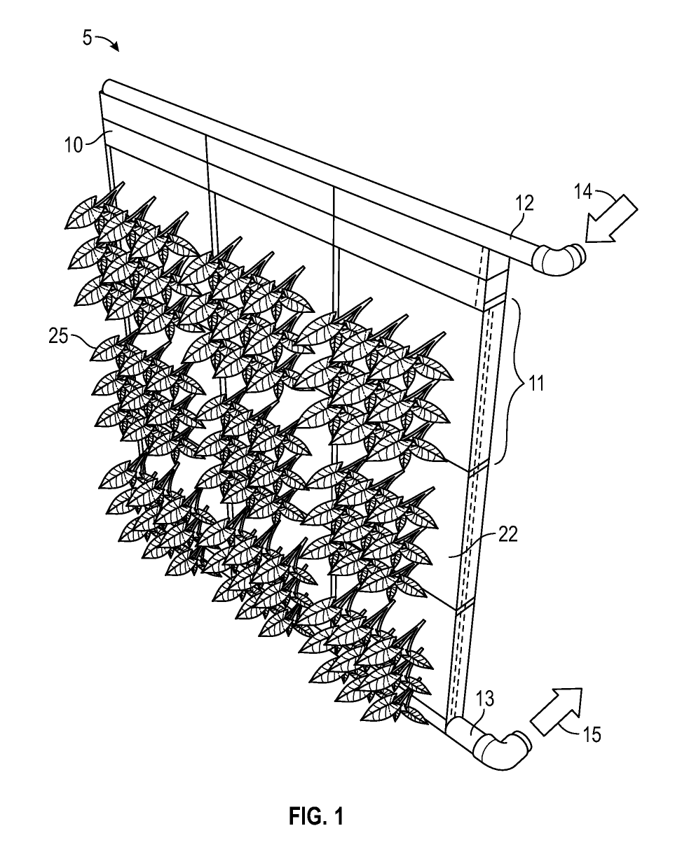

Referring now to FIGS. 1-5, an exemplary green wall system 5 is schematically depicted according to the present disclosure. As will be readily apparent to persons skilled in the art, the disclosed green wall system embodiments, including specifically the exemplary embodiment of FIGS. 1-5, are merely illustration.

With further reference to FIGS. 1-5, the exemplary green wall system 5 includes a plurality of cooperating components that cooperate to provide advantageous functionalities: a warm water distribution manifold 12; a water filtration sub-module 10; a cool water collection manifold 13; and a plant sub-module 11 with one or more plants 25 supported thereby. The warm water distribution manifold 12 is typically positioned at or near a top end of the green wall system 5 and distributes warm fluid/water for cooling therewithin.

In the exemplary embodiment of FIGS. 1-5, water filtration sub-module 10 is in fluid connection with the warm water distribution manifold 12 and/or the plant sub-modules 11. The water filtration sub-module 10 generally includes one or more filter portions or layers for filtering the warm system fluid it receives from either the warm water distribution manifold 12 via manifold openings associated therewith or a plant sub-module 11 positioned above it. As one skilled in the art will appreciate, exemplary embodiments of the disclosed systems and methods may include more than one water filtration module 10, and the location of the water filtration module(s) 10 may be spaced from each other to establish breaks in the filtration operations. The filtration properties and/or filtration media associated with individual filtration module(s) may be varied to target specific filtration objectives. Indeed, as shown in FIG. 3, the water filtration module 10 may include a plurality of layers of water filtration media, e.g., layer 18 and layer 19. The water filtration media included in layers 18, 19 may be selected to achieve a desired level of water filtration, as is known to persons skilled in the art.

With specific reference to FIG. 5, an exemplary water filtration module 10 is shown in greater detail. Water filtration module 10 include first and second horizontally aligned filtration media 21, 22 in a vertically stacked side-by-side orientation. Water filtration module 10 includes a front face 28 that covers/protects the filtration media. A lip 27 is associated with the lower edge of water filtration module 10 to facilitate handing and mounting relative to plant sub-module(s) 11 (not shown in FIG. 5). A warm water distribution manifold 12 is positioned above filtration media 21 and functions to distribute/deliver warm water/fluid thereto. A side panel 26 is also shown in FIG. 5, which functions to provide further stability and integrity to water filtration module 10. An opposed side panel (not pictured) is generally provided to fully encase the filtration media.

In the exemplary embodiment of FIGS. 1-5, the top-most plant sub-module 11 is generally in fluid communication with the water filtration sub-module 10. Multiple plant sub-modules 11 may be combined to provide a desired heat transfer area for green wall system 5. Multiple plant sub-modules 11 may thus be placed in fluid communication with each other, thereby enhancing the modularity and flexibility of the disclosed systems/methods. For example, in the exemplary embodiment of FIG. 1, three plant sub-modules 11 are stacked one atop the next to define the full vertical extent of green wall system 5. Reference number 11 is associated with a bracket that identifies the top-most plant sub-module 11. The present disclosure may be implemented with any number of plant sub-modules, provided fluid flow to and from the individual plant sub-modules 11 is designed to ensure flow from warm water distribution manifold 12 to cooled water collection manifold 13 which is typically located at or near the base of green wall system 5.

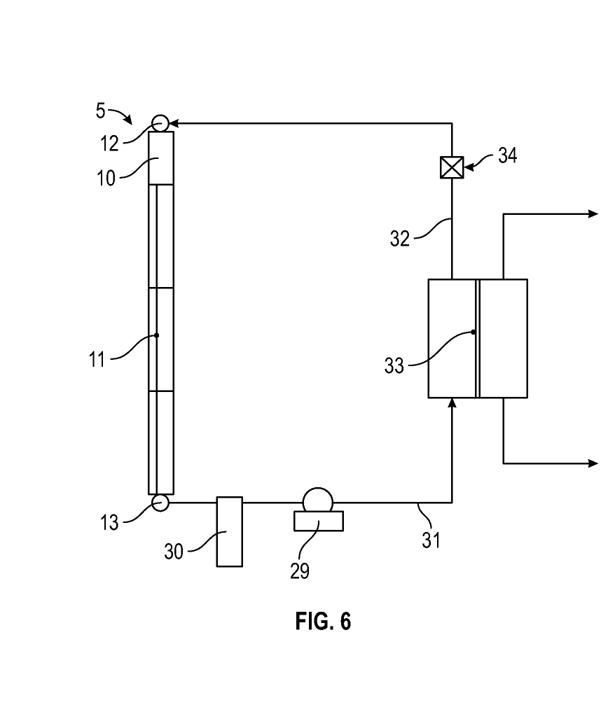

The cooled water collection manifold 15 is generally in fluid communication with a recirculation module (see FIG. 6). Arrow 15 exiting the cooled water collection manifold 13 of FIG. 1 shows the flow of cooled water that may be recirculated to a heat exchanger or other unit operation to collect further heat, and then the warmed water may be returned to the top of the green wall system 5.

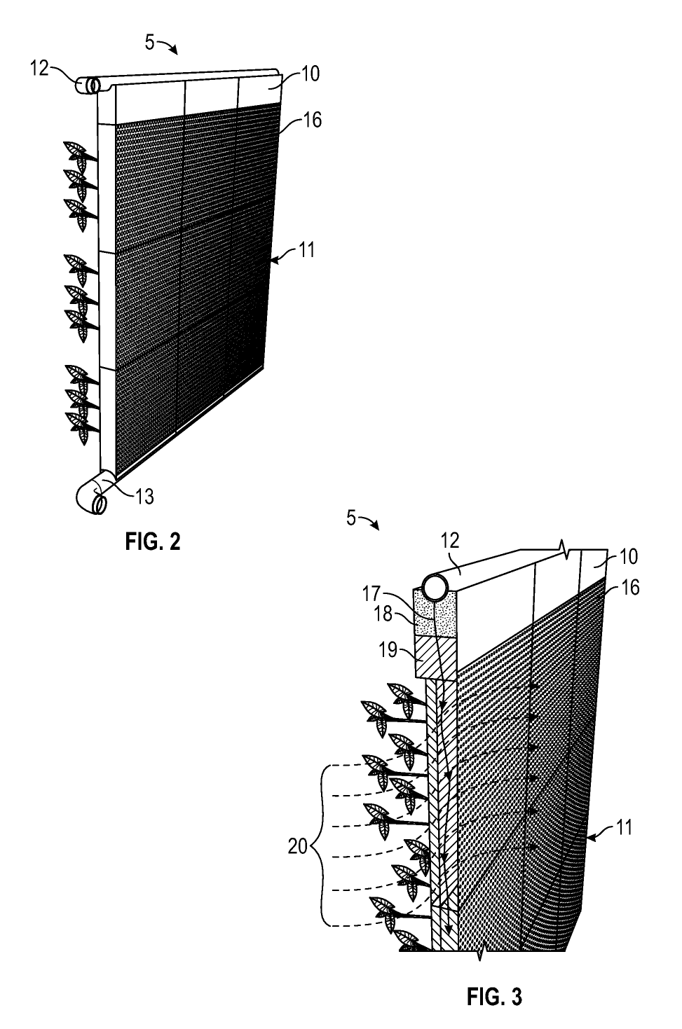

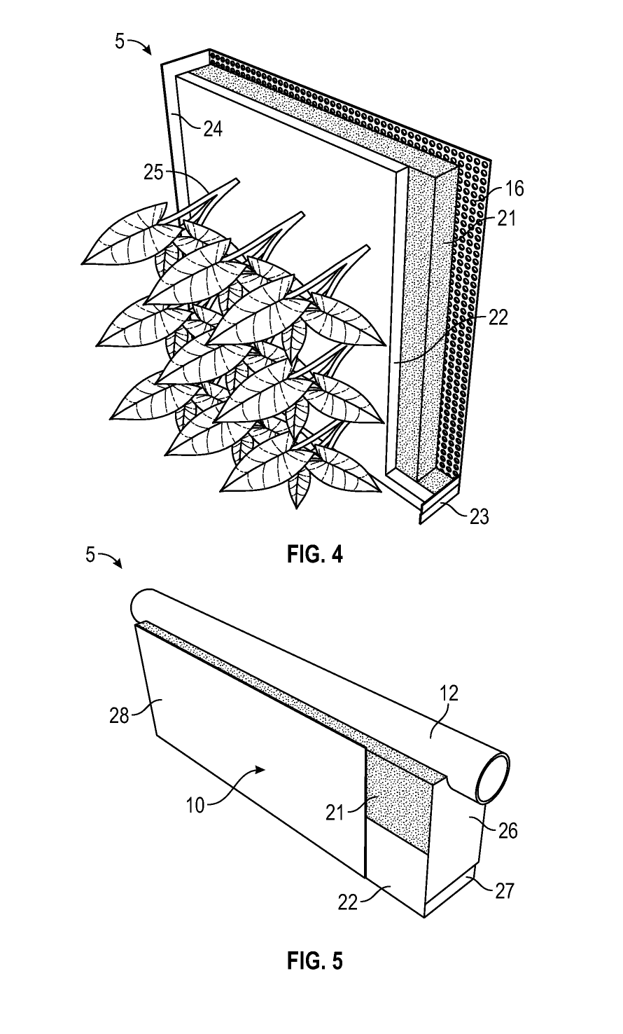

With reference to FIGS. 2-5, the disclosed plant sub-module 11 includes a housing or assembly that defines two opposed sides and a perforated back 16 that generally extends from side-to-side and is configured to constrain water flow to a vertical passageway/flow pattern while allowing generally transverse airflow therethrough. The plant sub-module(s) 11 may include side panels, e.g., side panel 24 (see FIG. 4) to provide structural integrity thereto. In some embodiments, the plant sub-module housing 15 includes a lip 23 that enables/facilitates stacking of the plant modules 15 with a mechanical interlock or other joining structure (e.g., slot in groove) for registration.

Referring specifically to FIG. 3, the dashed flow arrows 17 show the downward vertical flow path of the warm water from the warm water distribution channel 12 and the dashed arrows 20 show the generally cross-flow and partially counter-flow path of ambient air flowing through the heat-rejecting green wall system 5 from front-to-back. Airflow over the surface of the front and back of the plant module may contribute to convective heat and mass transfer. The cross-flow and surface-convective flow of ambient air is facilitated by the perforated back 16 of the plant sub-module(s) 11, i.e., the perforations permit outflow of ambient air after the cooling effect of such airflow is accomplished they also permit convective transfer at the surface which contributes to the cooling effect. The shape and distribution of the perforations formed in perforated back 16 of the plant sub-module(s) 11 is not critical, provided the perforations permit sufficient/desired levels of airflow and surface convective contact without defeating the structural requirements of such back plate. Of note, the water filtration sub-module 10 generally does not permit cross-flow of ambient air.

The plant sub-module 11 generally include an exposed porous substrate 22 that directly supports plant growth while admitting generally transverse airflow, i.e., airflow as illustrated by arrows 20 in FIG. 3; transverse diffusion of liquid water and water vapor to the surface; and convective transfer of water vapor to the ambient air at the surface. One or more plants 25 are typically planted or otherwise germinated in the porous substrate 22. The exposed porous substrate 22 is generally positioned between the top and bottom ends of the plant sub-module 11 and the two sides thereof. In some embodiments, the plant sub-module 11 may include one or more layers of porous media 21 that is/are sandwiched between the exposed porous substrate 22 and the perforated back 16 thereof. In these embodiments, the layer(s) of porous media 21 provide the primary vertical water flow passageway (as shown by dashed arrows 17 in FIG. 3) through the plant sub-module 11 while admitting generally transverse airflow (as shown by dashed arrows 20 in FIG. 3); transverse diffusion of liquid water and water vapor to the surface; and convective transfer of water vapor to the ambient air at the surface. In some embodiments, the layer or layers of porous substrate 22 and/or porous media 21 may be formed from either one or more integrated layers, multiple layers that are overlapping, or separated layers.

As will be apparent to persons skilled in the art, the disclosed systems and methods utilize elements of conventional “living green wall” (LGW) technology, i.e., green wall systems with plants, substrate and irrigation systems placed in a structural framework typically supported on building walls. However, unlike conventional LGW technology, the disclosed systems and methods include structure(s) and feature(s) that provide additional porosity, e.g., one or more porous layers, to allow water (or other fluid) that is flowing (at least in part) through the porous layer(s) to exchange thermal energy with ambient air that is flowing in a generally transverse plane or over the exposed surface of the porous layers via evaporative and convective exchange while simultaneously providing the requisite irrigation for the green wall plants. Consequently, the added porosity or porous layer(s) serve to not only allow a cascading dispersal of the water flow (to maximize heat exchange surface area), but a concurrent counter or cross flow of the ambient air and or transverse diffusion of liquid water or water vapor to the exposed surface of the porous layers all at sufficient volumetric flow rates to provide practically useful levels of heat rejection.

In addition, to enable the use of grey water and to limit mineral salt accumulation due to evaporative losses, in some embodiments, a vertical flow biofiltration system, which relies in part on the biofiltration potential of the LGW plants, is integrated into the construction of the systems according to the disclosed subject matter. The extended surface area provided by the exposed porous substrate 22 and its intimate contact with the water enhances the biofiltration potential of the LGW plants.

Turning to the schematic flow diagrams of FIGS. 6-9, four (4) exemplary system implementations are schematically depicted.

Referring first to FIG. 6, some embodiments of the disclosed subject matter include an open-circuit/natural draft system having an open-circuit system fluid recirculation loop with natural draft air movement through and over the modular living green wall system 5. In the embodiment schematically illustrated in FIG. 6, the system fluid passing through the living green wall system 5 (inward flow by way of warm water distribution manifold 12, water filtration sub-module 10, thru plant sub-module 11 and then outward flow through cool water collection manifold) is pumped by water recirculation pump 29 (from sediment/debris water filter 30) through feed line 31 for direct use as the process cooling fluid for a process 33 requiring heat rejection. As schematically depicted in FIG. 6, the heat exchange operation associated with process 33 may be based on co-current flow or counter-current flow. Alternative heat exchange operations may be implemented in process 33, as will be readily apparent to persons skilled in the art. After removing heat in process 33, the water flow recirculates through line 32 (and valve 34) to living green wall system 5. Of note, valve 34 may control introduction of make-up water to the open-circuit system of FIG. 6 (not shown)

In some embodiments, the system and associated method of the present disclosure may include a heat-rejecting living green wall system 5 coupled with a recirculation subsystem to remove heat from process cooling fluid, e.g., water, used to cool a process requiring heat rejection, e.g., a chiller, thermoelectric generation, solar thermal power generation, etc. For closed-circuit embodiments of the system, process cooling fluid is not delivered to the supply manifold 12. Rather, process cooling fluid is circulated through the heat exchanger loop, which is cooled by system fluid that is circulated through the heat-rejecting living green wall module. However, in all embodiments, system fluid is recirculated from the top to the bottom of the heat-rejecting living green wall module and returned to the top.

Still referring to FIG. 6, in some embodiments the heat-rejecting living green wall system 5 directly removes heat from the system fluid, i.e., also the process cooling fluid in this embodiment, via evaporative and/or convective cooling. The living green wall system 5 typically includes an open water flow segment of the water recirculation loop through which the warm process cooling fluid flows and is cooled via a cross-flow and partial counter-flow as well as convective/over-surface flow of ambient air. The recirculation module recirculates cooled process cooling fluid from the heat-rejecting living green wall module to a process requiring heat rejection and recirculates process cooling fluid heated by the process to the living green wall module. The recirculation module includes a conduit through which the process cooling fluid flows, a sediment/debris water filter 30 for filtering cooled water from the living green wall module before it is recycled to the process, a water recirculation pump 29 for drawing water from the living green wall module and to the process, and a make-up water supply line and valve 34 for supplying make-up water to the heat-rejecting living green wall module. The recirculation module typically provides volumetric flow rates well beyond that needed for irrigation alone. In some embodiments, the make-up water, which is used to make-up water lost to evaporation, is grey water.

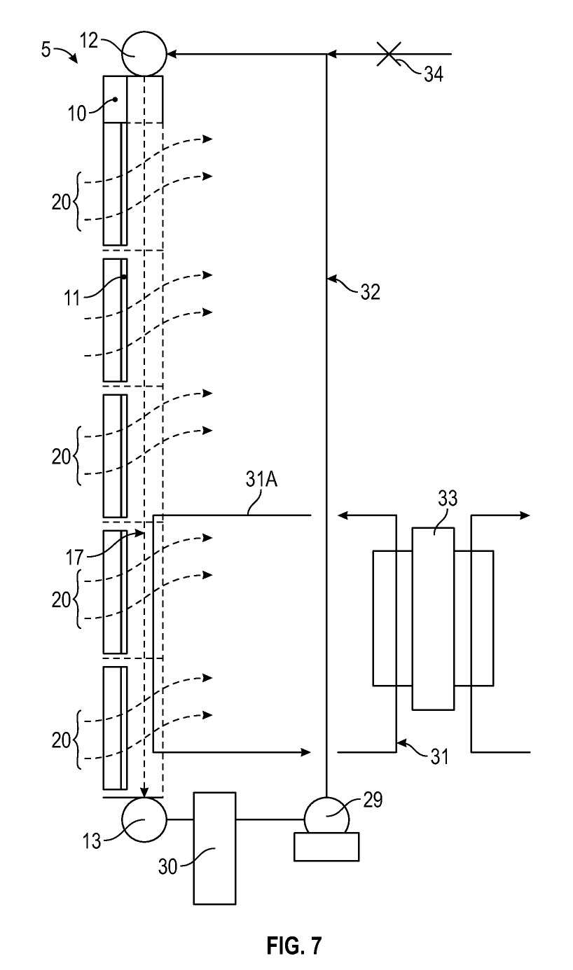

Referring now to FIG. 7, some embodiments of the disclosed subject matter include a system substantially similar to that illustrated in FIG. 6 and described above but having a closed-circuit recirculation loop used for the process cooling fluid with natural draft air movement through the living green wall system 5. In embodiments of the type schematically illustrated in FIG. 7, the system fluid passing through the living green wall system 5 and over a heat exchanger 33 is used to indirectly cool the process cooling fluid for the process requiring heat rejection.

Still referring to FIG. 7, in some embodiments, the system includes a heat exchange module 33 having a recirculation conduit 31A, a heat exchanger loop, and a process cooling fluid that is circulated via the conduit and loop through the process and through a lower portion of the living green wall module in a closed-circuit. The heat exchanger loop is typically positioned in a lower section of the living green wall system 5 to benefit from cooler system fluid water conditions there. The system fluid at least partially cools the process cooling fluid, i.e., to the extent provided by the heat exchanger efficiency.

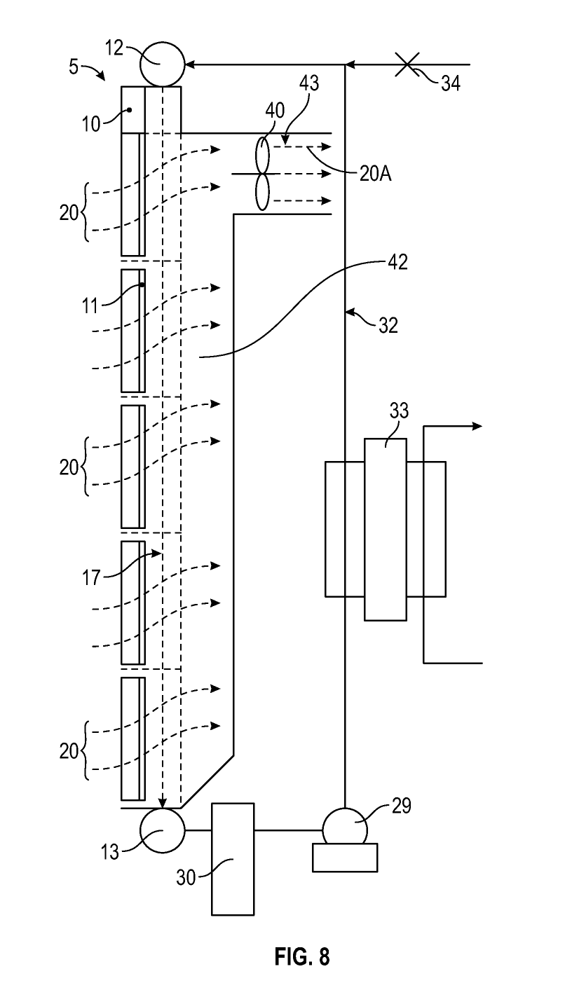

Referring now to FIG. 8, some embodiments of the disclosed subject matter include a system substantially similar to that illustrated in FIG. 6 and described above but having an open-circuit water recirculation loop with fan-driven, forced draft air movement through the heat-rejecting living green wall system 5.

Still referring to FIG. 8, in some embodiments, the system includes a forced draft module including a plenum 42 joined with a duct 43 and a mechanical fan 40 positioned within the duct 43, the plenum 42 being joined on the air outflow side of the heat-rejecting living green wall system 5 for collecting air drawn through the living green wall module 5 (as shown by arrows 20) at least in part by the fan 40 and expelled from duct 43 (as shown by arrows 20A).

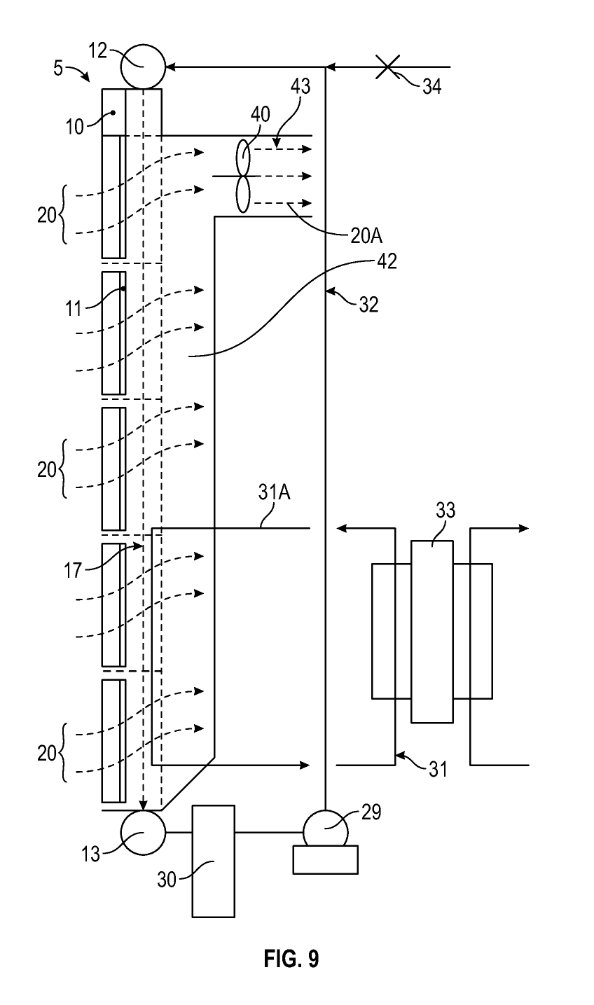

Referring now to FIG. 9, some embodiments of the disclosed subject matter include a system substantially similar to that illustrated in FIG. 6 and described above but having a closed-circuit recirculation loop used for the process cooling fluid forced draft air movement through the heat-rejecting living green wall system 5. Embodiments according to FIG. 9 represent a combination of the embodiments illustrated in FIGS. 7 and 8 and discussed above.

Again, this system fluid is not the process cooling fluid in the closed-circuit systems illustrated in FIGS. 7 and 9 and described above, but is the process cooling fluid in the open-circuit systems illustrated in FIGS. 6 and 8 and also described above. The dashed line exiting the supply manifold 12 at the top end of the living green wall shows the flow of warm system fluid requiring cooling flowing into the plant sub-module 11. The manifold 12 includes openings to allow the warm system fluid to exit the manifold 12 and flow into the heat-rejecting living green wall in a distributed manner.

In the open-circuit systems according to the disclosed subject matter, the recirculated water is continuously circulated from the process demanding heat rejection, e.g., building cooling systems, district chilled water system, thermo-power generation system, etc., to the LGW system providing the heat rejection. In the closed-circuit systems according to the disclosed subject matter, the recirculated water is continuously circulated through porous layer of the LGW to provide the heat rejection needed, while a separate coolant, e.g., water, is circulated in a closed piping system placed within the porous layers of the LGW with a recirculation loop passing through heat exchangers serving the process that demands heat rejection.

Systems according to the disclosed subject matter pairs green wall technology, which provides some limited passive thermal advantages, to heat rejection technology to actively cool buildings or other processes. As systems according to the disclosed subject matter provide an alternative technology to wet cooling towers they may serve the heat rejection needs of district chilled water production, larger building cooling systems, thermoelectric power generation, and a variety of industrial applications.

In addition, systems according to the disclosed subject matter can serve the heat rejection needs of smaller building cooling systems that currently depend on air-cooled heat rejection. In addition, the wet-cooling heat rejection offered by systems according to the disclosed subject matter typically provide significantly greater coefficients of performance or efficiencies than would be possible with air-cooled cooling systems and thus provide an additional energy savings and cost advantage.

In arid climates, systems according to the disclosed subject matter may be used to provide direct cooling bypassing the need for the process equipment normally served by cooling tower technology. Thus, for example, water from systems according to the disclosed subject can be circulated directly from the system to building slabs to effect slab-cooling of building interiors.

Aspects of the disclosed subject matter include a heat-rejecting living green wall system, which is a transformation of conventional living green wall systems to provide a sustainable alternative to wet cooling towers that are commonly used to provide heat rejection for a variety of building, utility, and industrial processes. Furthermore, heat-rejecting living green walls include four generic embodiments commonly found in cooling tower configurations: 1) open-circuit natural draft; 2) closed-circuit natural draft; 3) open-circuit forced draft; or 4) closed-circuit forced draft systems.

Systems according to the disclosed subject matter provide one alternative heat rejection technology to conventional wet cooling towers (CTs) that offers, by comparison, operational and energy conservation advantages, e.g., operationally they avoid or minimize the need for biocides and corrosion inhibitors, the problem of blow-down water disposal, and the need for annual shut-downs and steam cleaning. With regard to energy conservation, natural draft systems according to the disclosed subject avoid fan power consumption, and both natural and forced draft systems can benefit from nocturnal convective and radiative cooling in dry climates. Furthermore, cooling towers recirculate water with the sole purpose of heat rejection, while systems according to the disclosed subject use that recirculated water to maintain a LGW that may serve a number of additional purposes, e.g., water quality treatment, urban microclimate moderation, and wildlife habitat, as well as providing the benefits of conventional LGW systems.

Systems according to the disclosed subject matter transform conventional green wall technology—a passive technology from a building energy perspective—into an active heat rejection technology to provide another sustainable alternative to cooling towers. In comparison to cooling ponds or constructed wetlands adapted to heat-rejection purposes, systems according to the disclosed subject matter offer the following benefits: 1) systems according to the disclosed subject matter have the potential to dramatically increase the heat and mass transfer area available relative to the nominal surface area of the systems—the area most closely related to first and operating costs—and thereby provide improved performance; 2) systems according to the disclosed subject matter mitigate the problem of availability and cost of the “real estate” needed to otherwise construct a heat-rejecting cooling pond or constructed wetland; and 3) the primary objective to shade cooling ponds or constructed wetlands to limit solar heating and thereby to maximize heat rejection is conveniently resolved by systems according to the disclosed subject matter as shading will result directly from the dense vegetation provided by the green wall plant communities typically used and by the building for some orientations.

Furthermore, systems according to the disclosed subject matter may be designed to manage water quality, which opens up the possibility of using building grey water to make up for evaporative losses and thereby conserving water.

Systems according to the disclosed subject matter offer the following additional benefits over existing cooling tower technology and other known systems: strategic water conservation; energy conservation; and operational benefits.
Strategic Water Conservation: Cooling towers recirculate water with the sole purpose of providing heat rejection. In the process, significant amounts of water are lost by evaporation to the atmosphere and lesser amounts, i.e., on the order of 10% of the former, typically, are removed as blow-down water that is often so contaminated as to present a disposal challenge. Systems according to the disclosed subject matter, on the other hand are designed specifically to use the recirculated water to maintain system plants and substrate microorganisms so that they, in turn, can provide a range of beneficial ecosystem services, e.g., temperature and microclimate moderation, building grey water management, biofiltration of ventilation air, etc. Systems according to the disclosed subject matter allow strategic (pre)use of the recirculated water while cooling towers do not.
Energy Conservation: Cooling towers and systems according to the disclosed subject matter reject heat using the same heat transfer mechanisms—principally, evaporative and convective transport. Consequently, systems according to the disclosed subject matter do not provide an alternative heat transport mechanism that could lead to energy conservation differences. However, in some embodiments, systems according to the disclosed subject matter directly offset the fan power consumption required of many cooling towers, providing an energy savings nearly equal to the recirculation pumping power required of both systems according to the disclosed subject matter and cooling tower systems. Furthermore, systems according to the disclosed subject matter offer the possibility of water-cooled heat rejection to the large number of residential and smaller scale commercial buildings that rely on air-cooled heat rejection due to higher first costs, higher operational costs, and greater operational complexity of cooling tower technology.
Operational Benefits: Biocides to limit bacterial growth and corrosion inhibitors are invariably added to the recirculation water of cooling towers. In addition, evaporative losses from this water result in mineral salt concentration. Consequently, blow-down water is periodically removed from cooling tower water so that the remaining water can be diluted to reduce mineral salt concentrations in the water and thereby limit corrosion. Furthermore, the blow-down water is commonly so contaminated with biocides, corrosion inhibitors, and mineral salts that disposal may require additional processing. On top of these operational difficulties—and their associated costs—properly maintained cooling towers may be steam-cleaned annually. Properly designed systems according to the disclosed subject matter may not require biocides or corrosion inhibitors, as the general health of the plant ecosystem will obviate the former and the inclusion of salt tolerant plants will serve to limit the latter; nor will they require annual steam cleaning, although they will require maintenance.

### Example 1

Two side-by-side thermo green walls (LGWs) were fabricated and tested in four heat-rejecting experiments. In each test, four different media, namely 10 mm Enkamat® mat, a substrate, Ikea nonwoven mesh, and a DuraCool Pad, were used. The media allowed for 500-800 W/m² of heat rejection. A MATLab Simscape model was created to verify experimental results. The model's specific rejection results varied from 620-670 W/m² of LGW face area. This level of heat rejection is generally significant in comparison to common building cooling needs (15-35 W/m² of floor area) and can therefore serve as a viable substitute for cooling towers. The experimental testing and results are described in greater detail below.

Materials and Methods

Two side-by-side 11.25″ by 72″ LGW prototypes were fabricated from steel slotted angles and expanded metal. A manifold made of PVC pipe was installed at the top of the LGW with 1/16″ holes drilled along the manifold for water distribution. Under the manifold, a piece of geotextile material was added to simulate the water filtration system at the top of the LGW. A porous media was fixed to the expanded metal backing of each prototype with zip ties, and seven (7) thermocouples were either zip tied or simply forced into the media equidistance along the LGW (media type governed the thermocouple attachment method). One thermocouple was designated to measure air temperature.

Water was pumped using a ¼ horsepower submersible pump through a SmartWater filter, to a hot water heater, through a F-45376L-6 flow meter, and to the supply manifold. Water flowed out of the manifold and to the media at rates of either 1 or 1.5 liters per minute (LPM). Water then fell into a collection bucket where it was again pumped to the manifold. A Picotech thermocouple data logger transferred the thermocouple's water temperature readings to a Picotech software program. Heat rejection was calculated by using the specific heat capacity of water, the area of the LGW, the flow rate, and the water temperature measurements in the supply manifold and at the bottom of the LGW. The formula for specific heat rejection is:

heat rejection/m²=(LPM/60 sec)×(Tw1-Tw7)×Cp×(1/tGWarea)

Finally, a blue tarp shaded the panels from incoming solar radiation. A HOBOmeter was used to measure incoming visible radiation from the sun and reflected visible radiation from the panels; these measurements were transferred to the computer's HOBOware program.

Four 3-5 day tests with four different materials were conducted. For test 1, both panels were covered with a 10 mm Enkamat material—a material designed for erosion control. For test 2, Panel A was covered with the same Enkamat material and Panel B was covered with two layers: the Enkamat material and then a substrate material atop Enkamat material. For test 3, both panels were covered with two layers of an Ikea nonwoven polyester material. Finally, for test 4, both panels were covered with a DuraCool Pad.

As water flows down the media, mass and heat transfer occurs and takes the form of a dynamic heat and flow rate balance equation. There are solar gain (measured), advective gain, convective loss, conductive loss, long wave loss, and evaporative loss. The dynamic heat flow rate balance equation for a unit area of tGW is:
Conductive Solar Gains (measured): Inet
Advective Gain: +\dot{m}w Cp(Twin−Tw)
Convective Loss: −ha (Tw−Ta)
Conductive Loss: −hcon (Tw−Ta)
Long Wave Loss: −0.95σ((Tw+273.15)⁴−(Ta+273.15)⁴)
Evaporative Loss: −ρλm Ke(exp(19.1-5,350/Tw)−RH*exp(19.1-5,350/Ta))
Accumulation −Mw Cp (dTw/dt)
Where:=Tw=water temp. unknown; Ta=air temp. measured; \dot{m}w=water mass flow rate: controlled; Cp=specific heat capacity of water: constant; ha=convective heat transfer coefficient: constant; hcon=conductive heat transfer coefficient: constant; σ=Stefan Boltzman constant; ρ=density of water: constant; λm heat of evaporation of water: constant; Ke=mass transfer constant; RH=relative humidity of ambient air: measured; and Mw mass of water: measured.

Based on these governing equations for heat and mass transfer, a model that predicts experimental results was developed. This was realized within the MATLab Simscape computational simulation environment where conductive loss was assumed negligible due to minimal contact with the sides of the tGW prototype. The model was implement in the form of a tank in series model to account for the vertical variation of recirculated water temperature Tw.

### DISCUSSION OF RESULTS

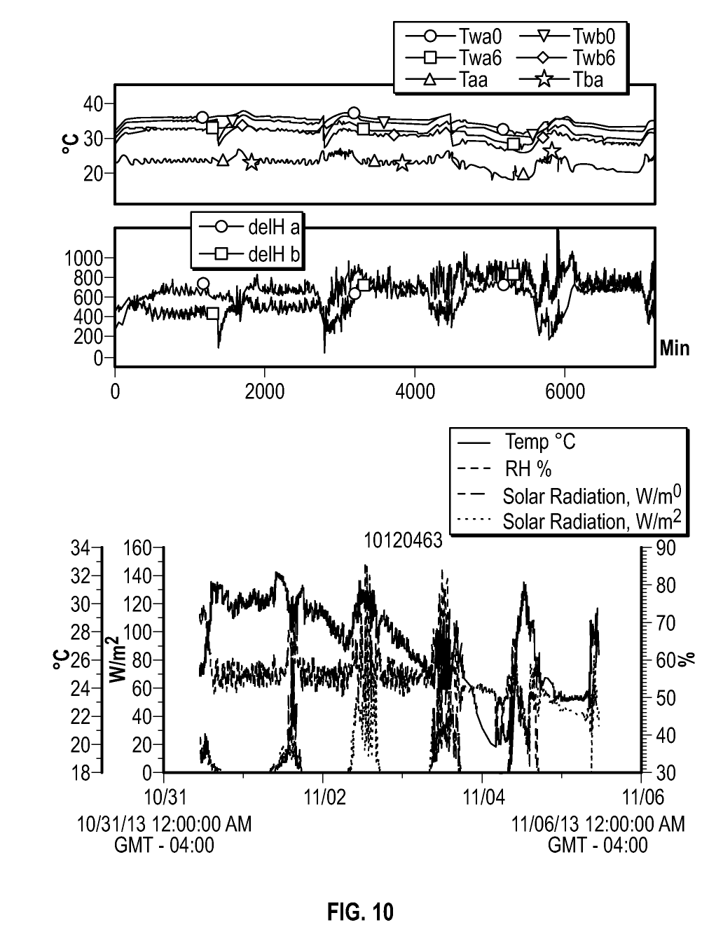

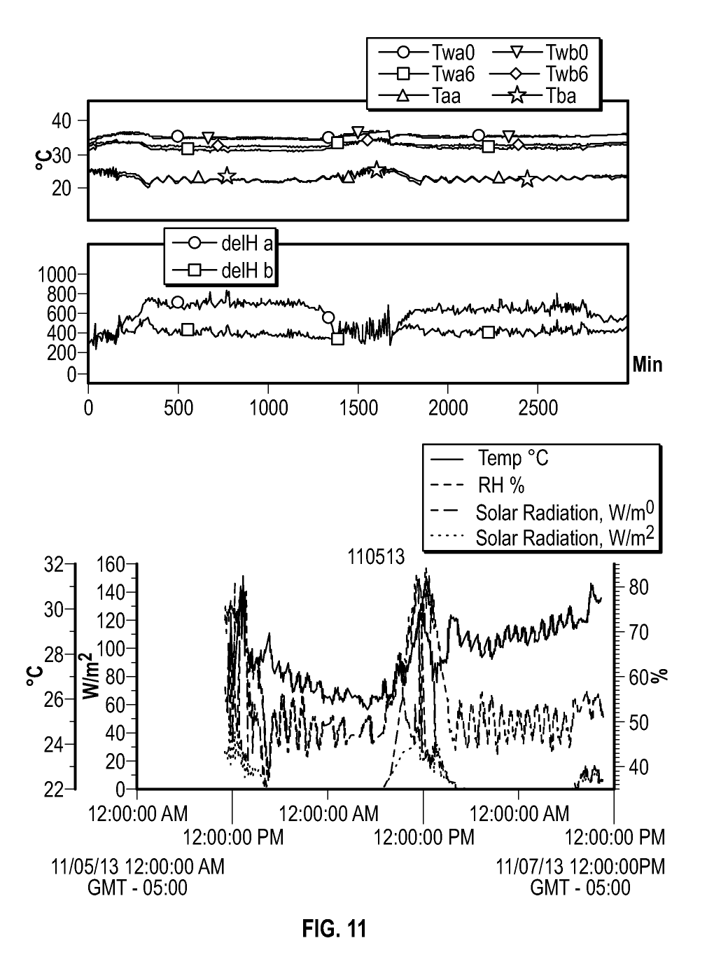

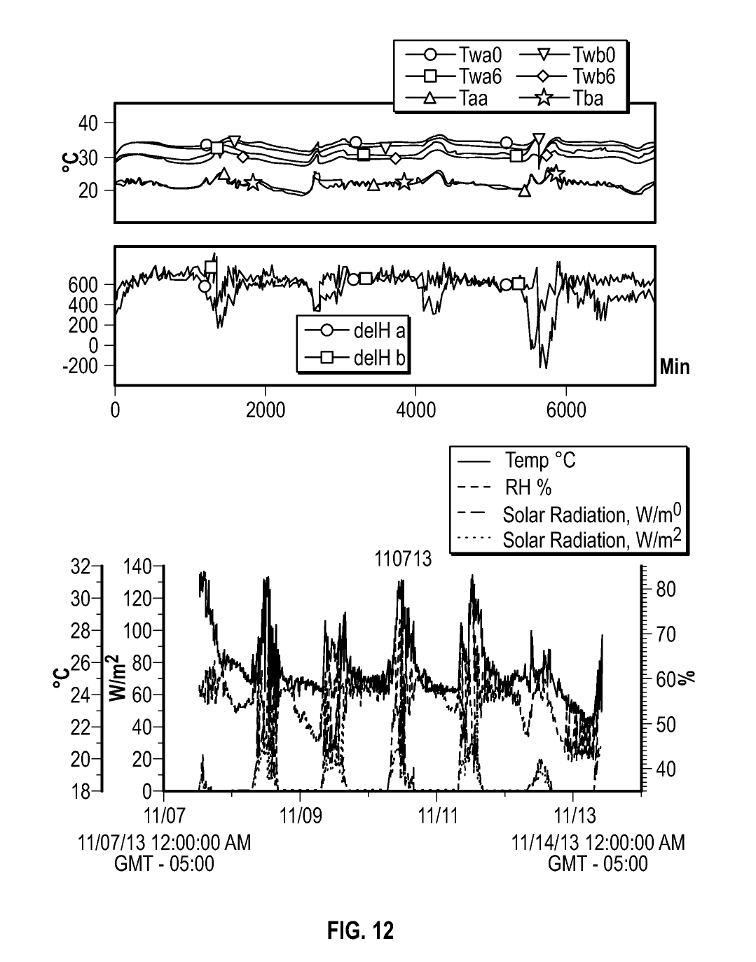

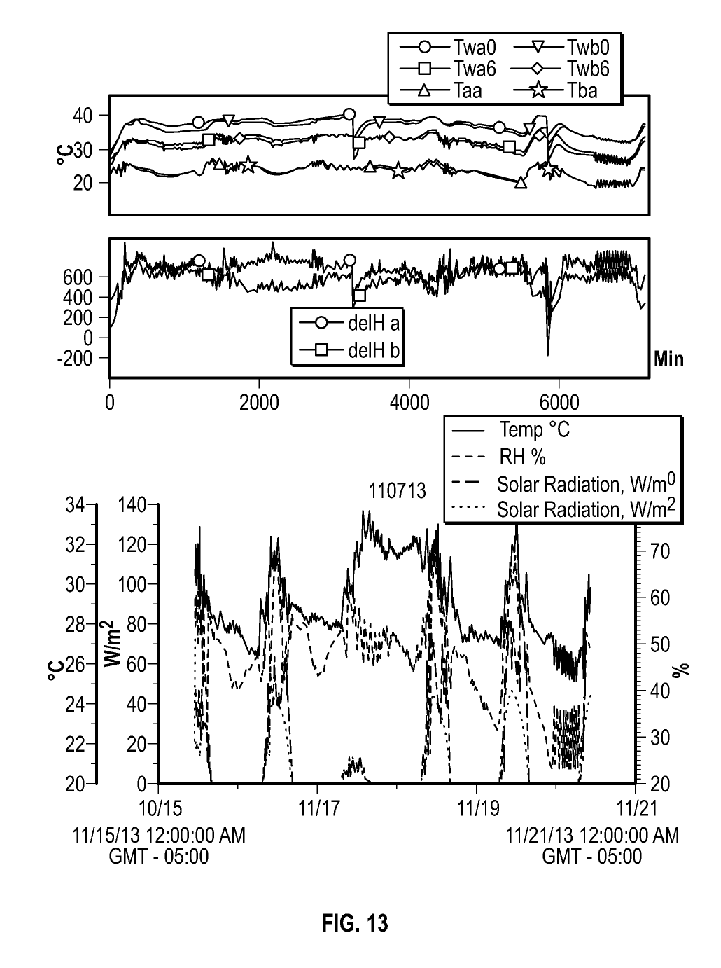

In all tests, there were temperature fluctuations. This can be attributed to the greenhouse space conditioning systems attempting to maintain constant temperatures by turning its heater on and off. Refilling the bucket that caught water flowing out of the LGW caused large dips in the temperature and therefore heat rejection. When the greenhouse's relative humidity increased, heat rejection decreased, which shows that LGWs are particularly effective in dry climates. This was expected because evaporative heat rejection is most effective when relative humidity is low. Finally, measured specific heat rejection rates ranged from 500-800 W/m², and the model showed that heat rejection would be from 620-670 W/m². Experimental results for the four tests are shown in FIGS. 10-13.

In Test 1, Panel A experienced 500-800 W/m2 of heat rejection and reached a steady state of about 700 W/m². Panel A experienced less heat rejection at the beginning because water was flowing over the expanded metal backing instead of through the media. To prevent this from occurring, the porous media was pulled away from the expanded metal. After it was pulled away, the heat rejection in panels A and B were about the same (700 W/m²). Most of the flow wicked along the grey textile backing instead of flowing over the more open nonwoven plastic. This was due to the greater water tension within the grey backing. The heat rejection from the experimental results also fell within the range of the model's predictive heat rejection (˜643 Wm²)).

In Test 3, the heat rejection ranged from 600-750 W/m² and reached a steady state at about 750 W/m². There was again significant flow over the expanded metal and frame of the LGW, which decreased the heat rejection potential. The model showed a heat rejection of about 623 W/m², which is lower than the experimental findings, but still within fluctuating range of measured heat rejection.

Finally, in Test 4, the heat rejection ranged from 500-800 W/m² and reached a steady state at about 800 W/m². The model showed that heat rejection would be about 680 W/m², which is lower than the experimental results, but again still within the measured heat rejection range. The DuraCool pad provided the greatest heat rejection, which was expected since DuraCool pads are designed for evaporative cooling. It did not provide, however, significantly more heat rejection than the Enkamat material or even the Ikea nonwoven polyester felt material. From these studies, it appears that the type of media used for evaporative cooling may not significantly affect the heat rejection in a LGW prototype. This is encouraging because media that allows plant growth while also serving as a heat rejecting media is desired for the disclosed systems/methods. Accordingly, media that supports plant growth and that rejects around 500-800 W/m² may prove appropriate according to the present disclosure.

### CONCLUSION

Four different tests measured the heat rejection in a LGW prototype. In all cases, the LGW rejected enough heat (500-800 W/m² per tGW surface area) to support typical building cooling loads of 15-35 W/m² per floor area—i.e., each nominal square meter of tGW could provide the heat rejection needed for roughly 20 to 30 square meters of building floor area. A model developed in the MATLab Simscape simulation environment was also created. The model predicted that 623-670 W/m² of heat rejection would occur, which falls within the range of experimental results.

The systems and methods of the present disclosure have been described with reference to exemplary embodiments and implementations thereof. It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed. For example, the disclosed systems and methods may be implemented by including certain features/functions only in certain of the modules to be associated with each other, e.g., only one/some of several green wall modules may be provided with a water filtration sub-modules and only one/some of several green wall modules may be provided with a plurality of plant sub-modules. Thus, the features and functions of the overall modular assembly may be varied by varying the components associated with individual modular building blocks. Additional modifications, refinements and/or improvements may be made to the disclosed systems and methods without departing from the spirit or scope of the present disclosure.

1. A system for removing heat from a liquid flow, comprising:
a plant module that includes an exposed porous substrate, a perforated back plate and at least one porous layer positioned between the exposed porous substrate and the perforated back plate.

2. The system of claim 1, wherein the at least one porous layer provides a primary flow path for the liquid flow.

3. The system of claim 1, wherein at least one porous layer includes a plurality of porous layers that are integrated, overlapped or separated relative to each other.

4. The system of claim 1, wherein the exposed porous substrate is effective to support plant growth and to permit transverse airflow therethrough and allow convective airflow over portions of exposed porous substrate surface.

5. The system of claim 1, further comprising at least one water filtration module positioned upstream of the plant module in some embodiments of the disclosure.

6. The system of claim 1, further comprising a warm water distribution manifold positioned upstream of the plant module.

7. The system of claim 1, further comprising a cool water collection manifold positioned downstream of the plant module.

8. The system of claim 1, further comprising a plenum positioned adjacent the perforated back plate, and a fan that draws air from the plenum and expels the air relative to the plant module.

9. The system of claim 1, further comprising a plurality of plants growing from the plant module.

10. The system of claim 1, wherein the plant module is positioned in an open circuit system that functions at least in part to provide cooling relative to a process that requires heat rejection.

11. The system of claim 1, wherein the plant module is positioned in an closed circuit system that functions at least in part to provide cooling relative to a process that requires heat rejection.

12. A system for removing heat from a cooling fluid, comprising:
a. warm water distribution module;
b. a water filtration sub-module in fluid communication with the warm water distribution module,
c. a plant module in fluid communication with the water filtration sub-module, the plant module including an exposed porous substrate, a perforated back plate and at least one porous layer positioned between the exposed porous substrate and the perforated back plate;
d. a plurality of plants growing from the exposed porous substrate; and
e. a cool water collection manifold in fluid communication with the plant module;
wherein transverse airflow through the plant module and convective surface airflow is effective to provide cooling to the cooling fluid passing therethrough.

13. The system according to claim 12, further comprising:
f. a heat exchange process in fluid communication with cooling fluid that enters the cool water collection manifold,
wherein the cooling fluid is recirculated in a warmed state to the warm water distribution channel after passing through the heat exchange process.

14. A method for removing heat from a cooling fluid, comprising:
a. feeding cooling fluid in a warmed state to a plant module that includes an exposed porous substrate, a perforated back plate and at least one porous layer positioned between the exposed porous substrate and the perforated back plate, and that further includes a plurality of plants growing from the exposed porous substrate;
b. removing heat from the cooling fluid by way of transverse air flow through the plant module and convective surface airflow over the module, and
c. feeding the cooling fluid after the heat removal to a heat exchange process so as to remove heat from a fluid flow requiring heat removal.

15. The method of claim 14, wherein the cooling fluid serves to irrigate the plurality of plants growing from the exposed porous media.

16. The method of claim 14, wherein the cooling fluid flows through at least one porous layer positioned between the exposed porous substrate and the perforated back plate.

17. The method of claim 14, further comprising promoting heat removal from the cooling fluid by way of transverse air flow through the plant module by way of a fan.

18. The method of claim 14, further comprising filtering the cooling fluid with one or more filtration media.

19. The method of claim 14, further comprising adding grey water to the cooling fluid that is fed to the plant module.

20. The method of claim 14, further comprising a recirculation loop selected from the group consisting of an open-circuit recirculation loop and a closed-circuit recirculation loop.
